(19) United States
(12) Patent Application Publication
(10) Pub. No.: US 2012/0237282 A1
(43) Pub. Date: Sep. 20, 2012

(54) LOOSE LEAF AND BINDER ASSEMBLY

(76) Inventor: Chin-Lien Ho, Taichung City (TW)

(21) Appl. No.: 13/334,164

(22) Filed: Dec. 22, 2011

(30) Foreign Application Priority Data
Mar. 15, 2011 (TW) 100204529

(51) Int. Cl. B42F 13/16

(52) U.S. Cl. 402/70

(57) ABSTRACT

A loose leaf and binder assembly includes a binder that includes a plurality of spaced apart closed rings extending around a common line, and a connecting rod connected integrally to all of the closed rings at one side of the common line. The closed rings are free of radial slits and are non-openable at junctions of the closed rings and the connecting rod. The binder has a robust reinforced structure and can be manufactured at reduced costs.

### CROSS-REFERENCE TO THE RELATED ART

This application claims priority of Taiwanese Application No. 100204529 filed on Mar. 15, 2011.

### BACKGROUND OF THE INVENTION

1. Field of the Invention

The present invention is related to a loose leaf and binder assembly, more particularly to a refillable loose leaf and binder assembly.

2. Description of the Related Art

In this era of information overload, loose-leaf binders provide convenience for our everyday life at work or in school. The use of loose leaves together with the binders allows the note pages to be held in place in a more organized and readable way. In addition, the supplement of loose leaves enables the expansion of the notebook.

The conventional loose-leaf binders generally can be divided into two categories. One is an openable ring binder, and the other is a fixed ring binder.

Referring to FIG. 1, the conventional openable ring binder has a spring-loaded member 51 associated with left half rings 52 and right half rings 53. When the left and right half rings 52, 53 are open, loose leaves can be added or taken out of the binder. When the left and right half rings 52, 53 are closed, the loose leaves can be held in place. However, during manufacturing, the left half rings 52 and right half rings 53 must be manufactured separately before they are assembled and loaded with a spring. Moreover, the space confined by the left half rings 52 and right half rings 53 limits the capacity for the inserted loose leaves. Therefore, the half rings 52, 53 will not be able to close completely when the loose leaves are over loaded, thus limiting the amount of loose leaves to be bounded.

Referring to FIGS. 2 and 3, a wire bound notebook disclosed in Taiwanese Utility Model No. TW M379515 includes a winding wire or coil having a series of interconnected C-shaped rings 54 to hold loose leaves that are provided with punched holes, and slits each extending between one of the punched holes and the edge of the respective loose leaf. The manufacturing cost for this kind of binding is relatively low, and more paper cab be bound. However, the C-shaped rings 54 are structurally fragile. When loose leaves are overloaded, the receiving spaces 55 of the C-shaped rings 54 are easily opened, therefore limiting usage of the C-shaped rings 54.

### SUMMARY OF THE INVENTION

Therefore, the object of the present invention is to provide a loose leaf and binder assembly that has a reinforced structure while still being able to be manufactured at low costs.

According to the present invention, a loose leaf and binder assembly comprises at least one binder that includes a plurality of spaced apart closed rings, all of which extend around a common line, and a connecting rod connected integrally to all of the rings at one side of the common line. The closed rings are free of radial slits and are non-openable at junctions of the closed rings and the connecting rod.

### BRIEF DESCRIPTION OF THE DRAWINGS

Other features and advantages of the present invention will become apparent in the following detailed description of the preferred embodiments of this invention, with reference to the accompanying drawings:

FIG. 1 is a perspective view of a conventional loose-leaf binder with openable rings;

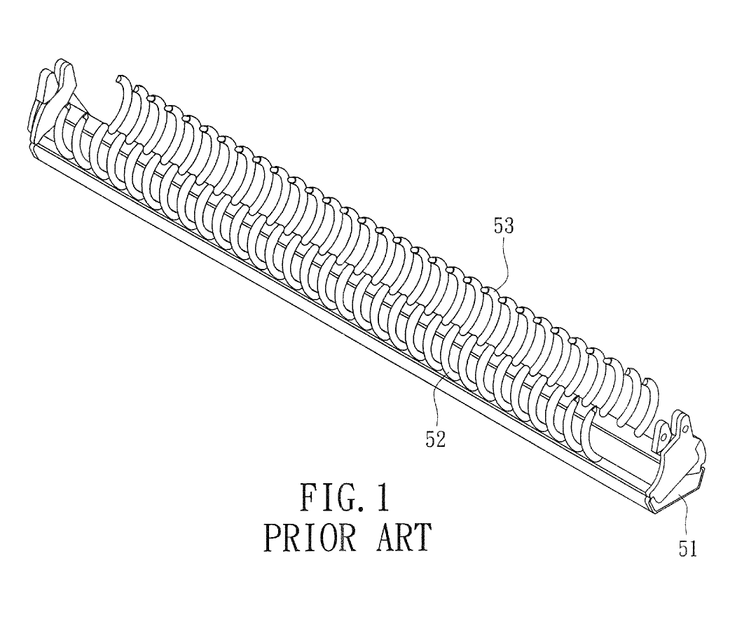

FIG. 2 is a perspective view of another conventional loose-leaf binder with a winding coil;

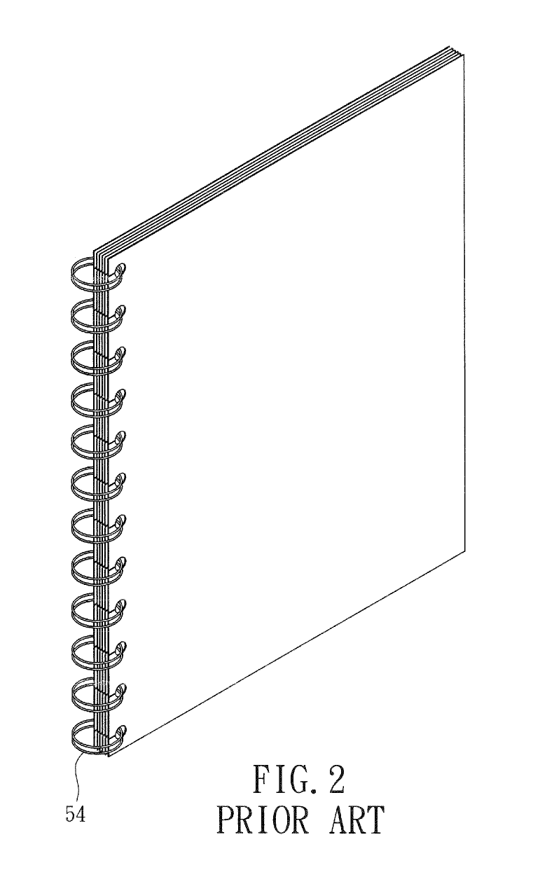

FIG. 3 is a perspective view of the conventional loose-leaf binder of FIG. 2 in an open state;

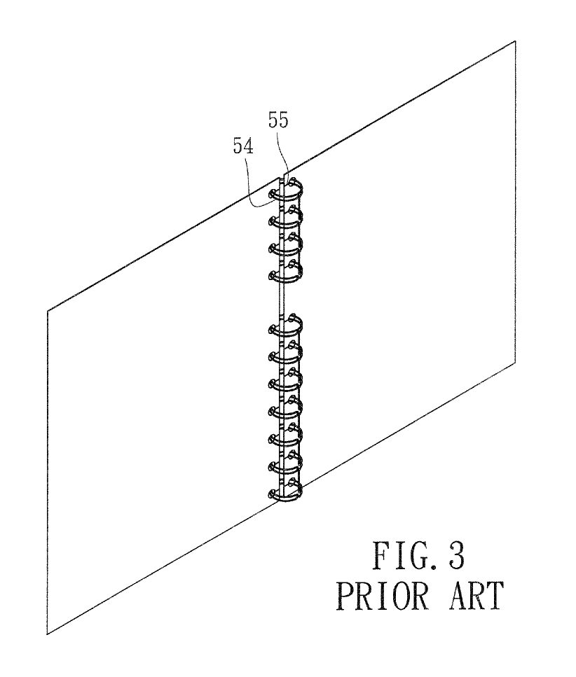

FIG. 4 is a perspective view of a loose leaf and binder assembly according to a preferred embodiment of the present invention;

FIG. 5 is a perspective view illustrating one of binders in the preferred embodiment of FIG. 4;

FIG. 6 is an enlarged fragmentary view of the preferred embodiment to illustrate one of closed rings and its relationship with a loose leaf and a cover sheet;

FIG. 7 is a perspective view of an alternative loose leaf with pockets usable in the preferred embodiment;

FIG. 8 is a perspective view illustrating two differently sized loose leaves used in the preferred embodiment;

FIG. 9 is a perspective view illustrating another preferred embodiment having two binders with different numbers of closed rings and two cover sheets of B5 paper size;

FIG. 10 is a perspective view illustrating still another preferred embodiment having one binder and two cover sheets of A5 paper size;

FIG. 11 is a perspective view illustrating still another preferred embodiment having two binders and two cover sheets of B4 paper size;

FIG. 12 is a perspective view illustrating still another preferred embodiment having one binder and two cover sheets of A4 paper size;

FIG. 13 is a perspective view illustrating still another preferred embodiment having two binders and two cover sheets of B6 paper size;

FIG. 14 is a perspective view illustrating still another preferred embodiment having two binders and differently sized loose leaves; and

FIG. 15 is a perspective view illustrating still another preferred embodiment having three binders and differently sized cover sheets.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

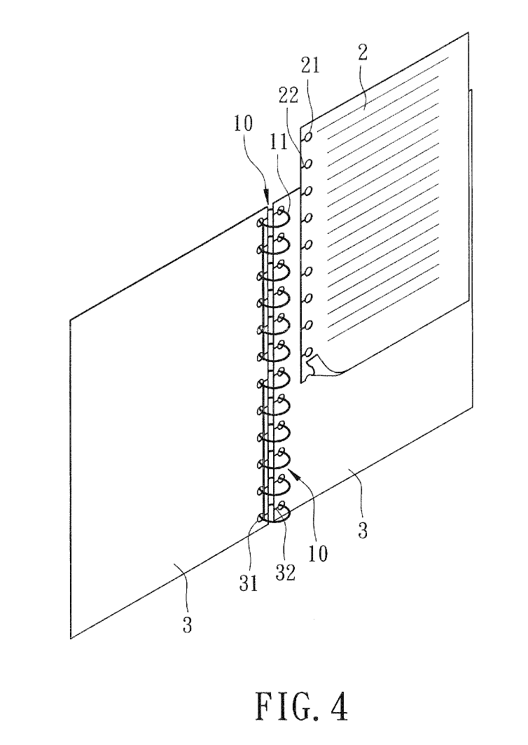

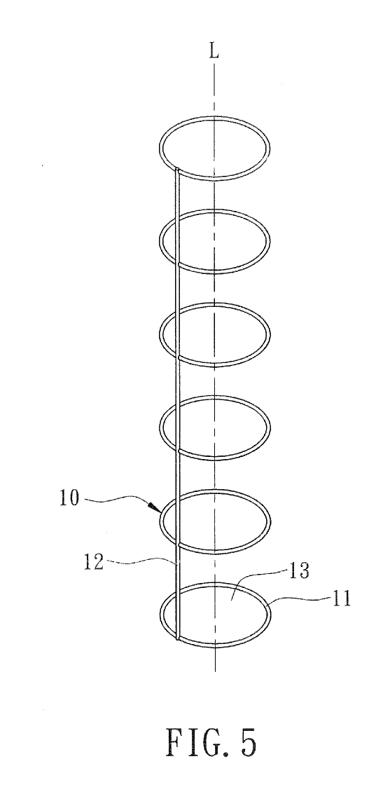

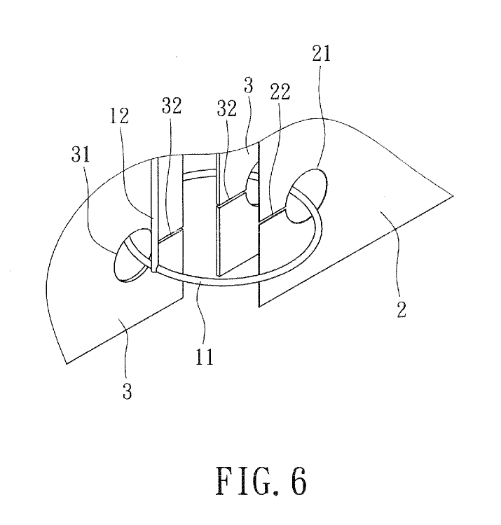

Referring to FIGS. 4, 5 and 6, a loose leaf and binder assembly according to a preferred embodiment of this invention includes two binders 10, multiple loose leaves 2 (only one is shown), and two cover sheets 3. Each binder 10 has a plurality of spaced apart closed rings 11, and a connecting rod 12. The closed rings 11 are connected to the connecting rod 12. The loose leaves 2 and the cover sheets 3 are attached to the closed rings 11.

The closed rings 11 are spaced apart at predetermined intervals, and extend around a common line (L).

The connecting rod 12 is substantially parallel to the common line (L) and is fixed to the closed rings 11 at one side of the common line (L). The closed rings 11 are free of radial slits and are non-openable at junctions of the closed rings 11 and the connecting rod 12. The closed rings 11 cooperatively define a holding space 13 for holding the loose leaves 2. The connecting rod 12 and the closed rings 11 form a one-piece integral body. In the preferred embodiment, the connecting rod 12 is substantially straight and cylindrical and is connected directly to a periphery of each of the closed rings 11. However, the shape and cross section of the connecting rod 12 should not be limited only thereto, and may be any other suitable shape.

Each loose leaf 2 includes an edge, several binding holes 21 near the edge, and slits 22. Each slit 22 extends from the respective binding hole 21 to the edge of the loose leaf 2. To be more specific, the width of the slits 22 should be smaller than the thickness of the closed rings 11, and the width of the binding holes 21 should be wider than the thickness of the closed rings 11. The loose leaves 2 are inserted into the holding space 13 by placing the binding holes 21 around the respective closed rings 11. In the preferred embodiment, the material for the loose leaf 2 may be polypropylene or any other suitable material.

The structure of the cover sheets 3 is similar to that of the loose leaf 2. Each cover sheet 3 has a plurality of binding holes 31, and slits 32 that extend from the respective binding holes 31 to an edge of the cover sheet 3. The width of the slits 32 in the cover sheets 3 should be smaller than the thickness of the closed rings 11. The width of the binding holes 31 in the cover sheet 3 should be larger than the thickness of the closed rings 11. For assembly, the slits 32 in the cover sheet 3 are opened to an extent that is wider than the thickness of the closed rings 11, and the binding holes 31 in the cover sheet 31 are aligned with the respective closed rings 11. Subsequently, the edge of the cover sheet 3 near the binding holes 31 is inserted into the closed rings 11, thus placing the edge of the cover sheet 3 into the holding space 13. Similarly, the same method is applied to insert the other cover sheet 3. In this preferred embodiment, the material for the cover sheet 3 is plastic. However, other materials may be used for the cover sheets 3.

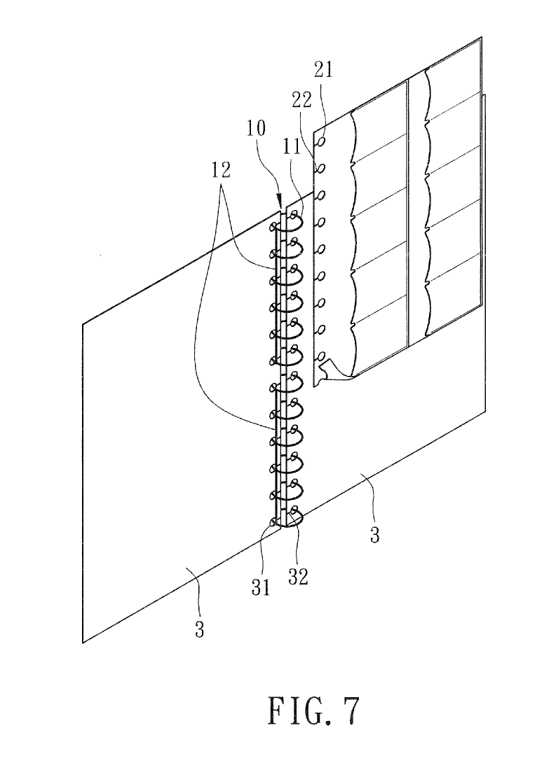

Referring to FIG. 7, the loose leaf 2 may be provided with pockets.

According to the present invention, the number of the closed rings 11 connected to each connecting rod 12 may be three to six.

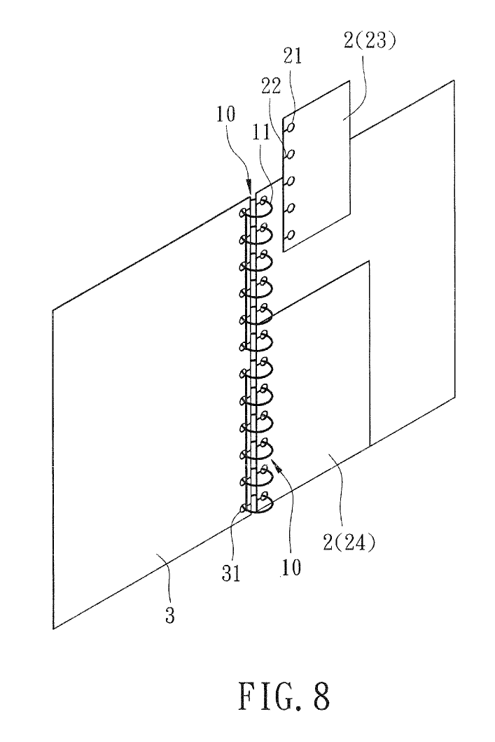

Referring to FIG. 8, the number of the binding holes 21 in the loose leaf 2 may be different from the number of the closed rings 11 connected to each connecting rod 12. As shown in FIG. 8, two differently sized loose leaves 2 respectively have five binding holes 21 and seven binding holes 21, and are bound together through the use of two binders 10. Two connecting rods 12 of the binders 10 are each connected to six closed rings 11. In addition, the size of the cover sheets 3 is a size of A3 paper. One of the loose leaves 2 is sized as a memorandum loose leaf 23, and the other loose leaf 2 is sized as a notebook loose leaf 24.

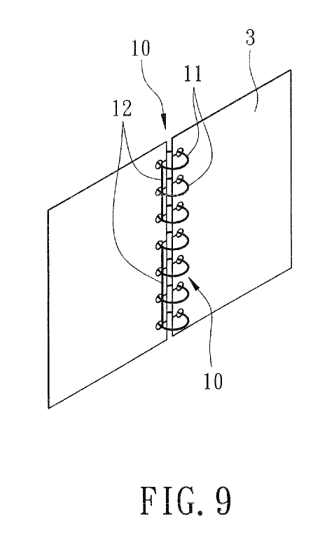

Referring to FIG. 9, another preferred embodiment of the present invention includes two connecting rods 12, one of which is connected to three closed rings 11, and the other one of which is connected to four closed rings 11. The size of the cover sheet 3 is equal to a size of B5 paper.

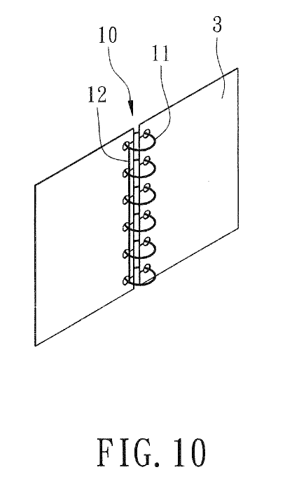

Referring to FIG. 10, still another preferred embodiment of the present invention includes a single binder 10, in which a connecting rod 12 is connected to six closed rings 11. The size of the cover sheets 3 is equal to that of an A5 paper.

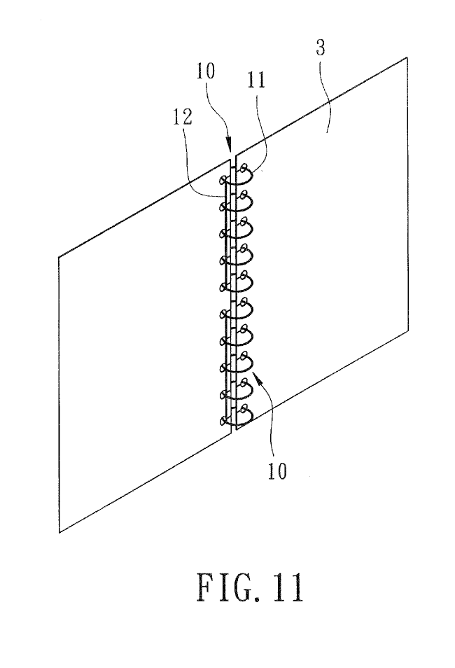

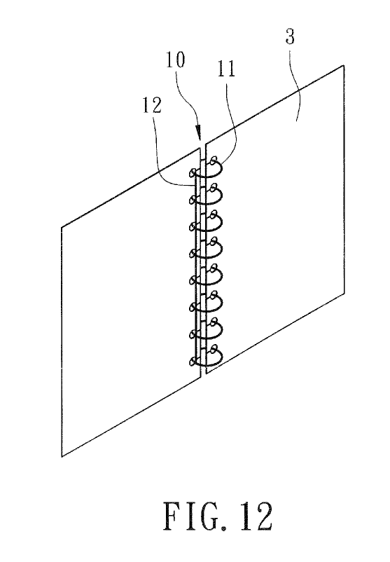

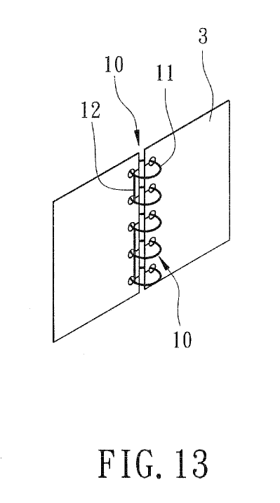

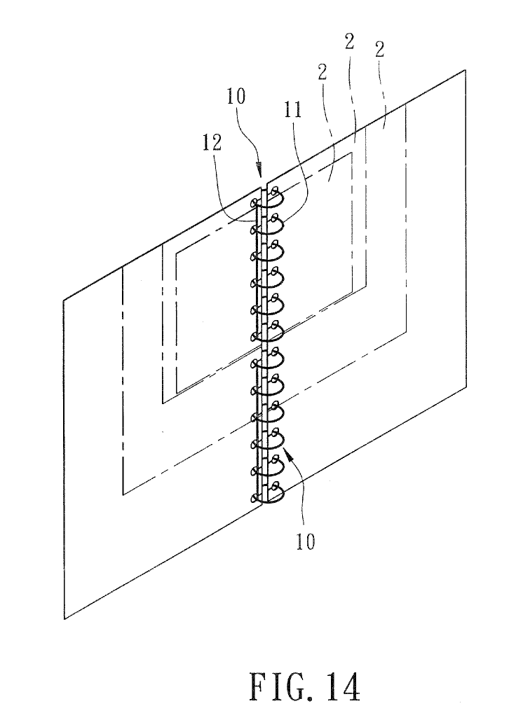

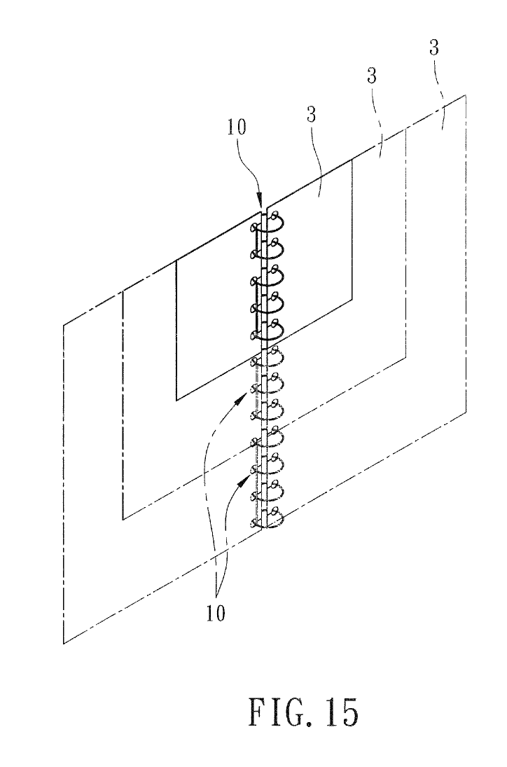

FIGS. 11, 12 and 13 respectively show a B4 paper size, an A4 paper size and a B6 paper size for the cover sheets 3. Referring to FIG. 14, three differently sized loose leaves 2 are bound together using two binders 10. Referring to FIG. 15, three differently sized cover sheets 3 are associated with three binders 10.

As described hereinbefore, in the preferred embodiment shown in FIGS. 4 to 6, there are six closed rings 11 connected to the connecting rod 12 to form each of the binders 10. The two binders 10 are arranged in series. The size of the loose leaf and binder assembly can be adjusted flexibly by choosing a suitable number of the binders 10. For example, two binders 10 are suitable for the loose leaves 2 having the size of A4 paper. Four binders 10 are suitable for the loose leaves 2 having the size of A3 paper.

Referring back to FIG. 4 when the loose leaf 2 is inserted into the binder 10, the slits 22 should be expanded to a width wider than the thickness of the closed rings 11 to pass through the respective closed rings 11 and to permit the binding holes 21 of the loose leaf 2 to encircle the respective closed rings 11.

In sum, the advantages provided by the present invention include:
1. The closed rings 11 and the connecting rod 12 form a one-piece integrated body. During manufacturing, unlike the conventional loose leaf binders, the one-piece integrated body can be produced by injection molding without requiring the step of assembling individually manufactured component parts, thus reducing the manufacturing cost.
2. Since the closed rings 11 and the connecting rod 12 form an one-piece integrated body, which has a robust reinforced structure, and since the closed rings 11 are free of slits and not openable, the loose leaf and binder assembly of the present invention will not easily burst or break when the number of the loose leaves 2 filled in the closed rings 11 is increased.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A loose leaf and binder assembly comprising:
at least one binder that includes a plurality of spaced apart closed rings all of which extend around a common line, and a connecting rod connected integrally to all of said closed rings at one side of said common line,
wherein said closed rings are free of radial slits and are non-openable at junctions of said closed rings and said connecting rod.

2. The loose leaf and binder assembly of claim 1, wherein said connecting rod is a substantially straight rod that is substantially parallel to said common line and that is connected directly to a periphery of each of said closed rings.

3. The loose leaf and binder assembly of claim 1, further comprising a plurality of loose leaves, each of which has an edge, and a plurality of binding holes proximate to said edge, said closed rings respectively extending through said binding holes, said edge extending into said rings.

4. The loose leaf and binder assembly of claim 3, wherein each of said loose leaves further has a plurality of slits, each of which extends from a respective one of said binding holes to said edge, said slits permitting said edge to split and extend into said closed rings.

5. The loose leaf and binder assembly of claim 1, further comprising two cover sheets, each of which has an edge, a plurality of binding holes proximate to said edge, and a plurality of slits, each of said slits extending from a respective one of said binding holes to said edge, said slits permitting said edge to split and extend into said closed rings.

6. The loose leaf and binder assembly of claim 1, wherein said closed rings and said connecting rod are made from a plastic material.

7. The loose leaf and binder assembly of claim 1, wherein said connecting rod is connected to three to six said closed rings.

8. The loose leaf and binder assembly of claim 3, wherein at least one of said loose leaves has at least one pocket.

9. The loose leaf and binder assembly of claim 3, wherein the number of said binding holes in each of said loose leaves is equal to that of said closed rings.

10. The loose leaf and binder assembly of claim 3, wherein the number of said binding holes in each of said loose leaves is different from that of said closed rings.
